(19) United States
(12) Patent Application Publication
(10) Pub. No.: US 2014/0236627 A1
(43) Pub. Date: Aug. 21, 2014

(54) DYNAMIC MEDICAL SCHEDULING SYSTEM AND METHOD OF OPERATION THEREOF

(71) Applicants: Adam Odessky, San Francisco, CA (US); Joseph Arceneaux, San Francisco, CA (US)

(72) Inventors: Adam Odessky, San Francisco, CA (US); Joseph Arceneaux, San Francisco, CA (US)

(73) Assignee: ORANGE, Paris (FR)

(21) Appl. No.: 14/129,477

(22) PCT Filed: Jun. 26, 2012
(86) PCT No.: PCT/IB2012/001381

§ 371 Date: May 5, 2014

Related U.S. Application Data
(60) Provisional application No. 61/502,780, filed on Jun. 29, 2011.

(51) Int. Cl. G06F 19/00

(52) U.S. Cl. CPC G06F 19/327; G06F 19/322
USPC 705/3; 705/2

(57) ABSTRACT

A scheduling system which may include at least one controller which may obtain sensor information including one or more of biometric information and location information related to a user; determine a medical symptom or medical condition of the user in accordance with the sensor information; schedule an appointment with a provider of professional services in accordance with the determined medical symptom or medical condition of the user; and/or notify one or more of the user and the medical provider of the scheduled appointment.

### FIELD OF THE PRESENT SYSTEM

The present system relates to a medical scheduling system and, more particularly, to an automated medical scheduling system and a method of operation thereof.

### BACKGROUND OF THE PRESENT SYSTEM

Typically, scheduling of a patient's visit to a medical provider (MP) is not automated and must be performed on a patient-by-patient basis by a professional such as a member of the MPs staff. For example, an individual such as a patient must typically call in to his or her MP (e.g., a doctor such as the patient's general practitioner) to schedule an appointment during the MPs office hours. This process is time consuming, inefficient, and inconvenient. Further, as patients typically cannot properly diagnose their medical condition, they may schedule an appointment with an MP which cannot provide proper medical treatment. Accordingly, it may be necessary to schedule an appointment with a second MP which can provide proper medical treatment to the patient. As scheduling an appointment with a second MP may result in a delay of treatment, it may exacerbate medical conditions of the patient. Accordingly, there is a need for a medical scheduling system which can quickly and conveniently determine a medical condition of a patient and schedule an appointment for a patient with a selected suitable MP which can treat the patient's medical condition. Further, there is a need for a medical communication system which can determine a medical condition of a patient and arrange for a communication with a selected MP based upon the determined medical condition.

### SUMMARY OF THE PRESENT SYSTEM

In accordance with an aspect of the present system there is disclosed a scheduling system including at least one controller which may obtain sensor information for example including one or more of pain level information, symptom information (e.g., symptoms and/or body location information (e.g., “pain in lower right quadrant of abdomen” communicated by the patient, e.g., verbally, electronically, etc.), medical sensor, biometric information, and location information related to a user; determine a medical symptom or medical condition of the user in accordance with the sensor information; schedule an appointment with a provider of professional services (POPS) in accordance with the determined medical symptom or medical condition of the user; and/or notify one or more of the user and the medical provider of the scheduled appointment. It is further envisioned that the controller may further obtain one or more of an electronic medical record (EMR), an electronic health record (EHR), and personal health record (PHR) of the user from a memory of the system. Moreover, the controller may further determine the medical symptom or medical condition of the user in accordance with one or more of the electronic medical record (EMR), the electronic health record (EHR), and the personal health record (PHR) of the user. Moreover, it is envisioned that the controller may determine an urgency level in accordance with one or more of a pain level of the user and a risk level of the medical symptom or medical condition of the user. Further, it is envisioned that the controller may select one or more treatment options (TOs) to treat the medical symptom or medical condition of the user based upon the medical symptom or medical condition of the user. Moreover, the controller may further select the POPS from a plurality of POPS in accordance with the TOs or an urgency level.

In accordance with a further aspect of the present system there is disclosed a scheduling system including a method including acts which are performed by a processor, the acts may include acts such as: obtaining sensor information including one or more of medical sensor, biometric information and location information related to a user; determining a medical symptom or medical condition of the user in accordance with the sensor information; scheduling an appointment with a provider of professional services (POPS) in accordance with the determined medical symptom or medical condition of the user; and/or notifying one or more of the user and the POPs of the scheduled appointment. The method may further include an act of obtaining one or more of an electronic medical record (EMR), an electronic health record (EHR), and personal health record (PHR) of the user from a memory of the system. Moreover, the act of determining the medical symptom or medical condition of the user may be performed in accordance with information included in one or more of the electronic medical record (EMR), the electronic health record (EHR), and the personal health record (PHR) of the user. Moreover, the method may further include an act of determining an urgency level in accordance with one or more of a pain level of the user and a risk level of the medical symptom or medical condition. It is further envisioned that the method may include an act of selecting a treatment option (TO) to treat the medical symptom or medical condition. The method may further include an act of selecting the POPS from a plurality of POPS in accordance with one or more of the TO and the urgency level.

In accordance with a yet a further aspect of the present system there is disclosed a scheduling system including a computer program stored on a computer readable memory medium, the computer program may be configured to perform a scheduling process and may include a program portion configured to: obtain sensor information including for example one or more of medical sensor, user input information (e.g., symptom information such as a description of a patient's symptoms and/or a body location which may be electronically or verbally input by a user such as a patient), biometric information and location information related to a user; determine a medical symptom or medical condition of the user in accordance with the sensor information; schedule an appointment with a provider of professional services (POPS) in accordance with the determined medical symptom or medical condition of the user; and/or notify one or more of the user and the POPs of the scheduled appointment. It is further envisioned that the program portion may be further configured to obtain one or more of an electronic medical record (EMR), an electronic health record (EHR), and personal health record (PHR) of the user from a memory of the system. It is also envisioned that the program portion may be further configured to determine the medical symptom or medical condition of the user in accordance with one or more of the electronic medical record (EMR), the electronic health record (EHR), and the personal health record (PHR) of the user. Further, it is envisioned that the program portion may be further configured to determine an urgency level in accordance with one or more of a pain level of the user and a risk level of the medical symptom or medical condition. Moreover, it is envisioned that the program portion may be further configured to select one or more treatment options (TOs) to treat the (determined) medical symptom or medical condition of the user. Further, the program portion may be further configured to select the POPS from a plurality of POPS in accordance with the TOs or the urgency level.

### BRIEF DESCRIPTION OF THE DRAWINGS

The invention is explained in further detail, and by way of example, with reference to the accompanying drawings wherein:

FIG. 1 is a schematic view of a scheduling system in accordance with embodiments of the present system;

FIG. 2 shows a flow diagram that illustrates a process in accordance with embodiments of the present system;

FIG. 3 shows a flow diagram that illustrates a process in accordance with embodiments of the present system; and

FIG. 4 shows a portion of a system in accordance with embodiments of the present system.

### DETAILED DESCRIPTION OF THE PRESENT SYSTEM

The following are descriptions of illustrative embodiments that when taken in conjunction with the following drawings will demonstrate the above noted features and advantages, as well as further ones. In the following description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well-known devices, circuits, tools, techniques, and methods are omitted so as not to obscure the description of the present system. It should be expressly understood that the drawings are included for illustrative purposes and do not represent the scope of the present system. In the accompanying drawings, like reference numbers in different drawings may designate similar elements.

The term rendering and formatives thereof as utilized herein refer to providing content, such as digital media which may include, for example, electronic medical records (EMR), personal health records (PHR), electronic health records (EHR), biometric information, physiological information (e.g., vitals such as a patient's weight, blood pressure, glucose reading, heart rate, etc.), image information, medical device information (e.g., pacemaker information, physiological information generated by the corresponding medical device, etc.), information generated and/or accessed by the present system, messages, status information, settings, audio information, graphical information, visual information, audiovisual information (hereinafter, generally “MR”), etc., such that it may be perceived by at least one user sense, such as a sense of sight, a tactile sense, and/or a sense of hearing. For example, the present system may render a user interface (UI) on a display device so that it may be seen and interacted with by a user. Further for example, the system may display a patient's MR for the convenience of a user such as a provider of professional services (POPs).

Embodiments of the present system may interface with conventional medical scheduling systems or applications and/or other scheduling systems and/or applications such as Microsoft Schedule™, etc.

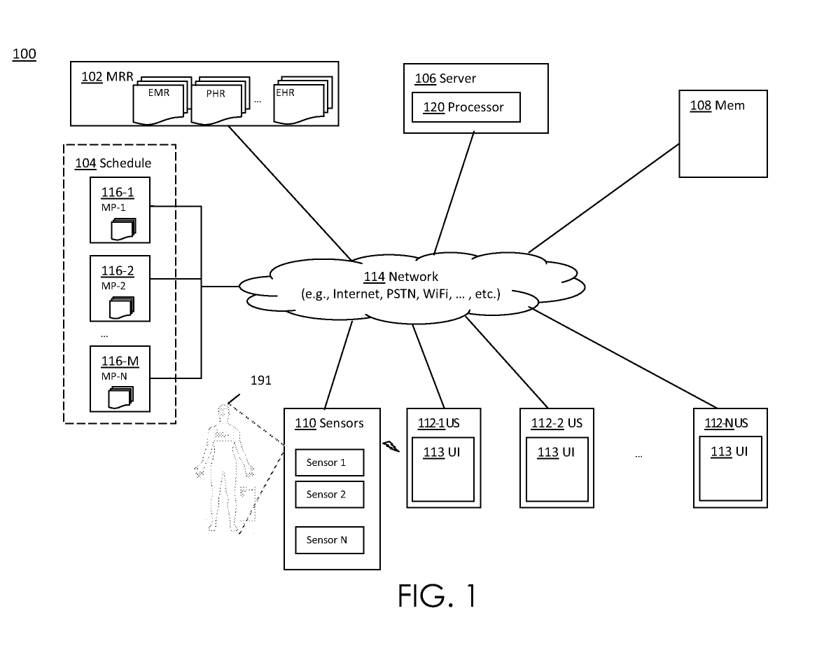

FIG. 1 is a schematic view of a scheduling system 100 in accordance with embodiments of the present system. The scheduling system 100 may include one or more of medical record resources (MRR) 102 (e.g., a source of MR), schedule resources 104, a server 106, a memory 108, sensors 110, and one or more user stations (US) 112-x.

The server 106 may include a one or more processors 120 which may be situated locally and/or remotely from each other and may control the overall operation of the system 100. Accordingly, the server 106 may communicate with one or more of the MRR 102, the schedule resources 104, the memory 108, sensors 110, and one or more of the USs 112-x to transmit and/or receive information. For example, the server 106 may request sensor information from one or more of the sensors 110, may request medical records associated with a user from the MRR 102, may request user inputs from an UI 112-x, etc. Further, the server 106 may store information (e.g., MR information, schedules, user information, account information, etc.) which it receives and/or generates, in a memory of the system such as the memory 108 for further use. Operations performed by the processor 120 may be performed using one or more processors, logic devices, or the like, which may be locally and/or remotely located relative to each other. For example, one or more processes performed by the processor 120 may be perfumed using one or more processor within a US 112-x, the sensors 110, etc.

The network 114 may include one or more networks and may enable communication between or more of the MRR 102, the schedule resources 104, the server 106, the memory 108, the sensors 110, and the one or more USs 112-x using any suitable transmission scheme such as wired and/or wireless communication schemes. Accordingly, the network 114 may include one or more networks such as a wide area network (WAN), a local area network (LAN), a telephony network, (e.g., a public switched telephone network (PSTN), a 3G network, a 4G network, a 5G network, a code division multiple access (CDMA) network, a global service for mobile (GSM) network, a plain old telephone service (POTs) network, etc.), a peer-to-peer (P2P) network, a wireless fidelity (Wi-Fi™) network, a Bluetooth™ network, a proprietary network, and or other communication networks.

The memory 108 may include any suitable device in which various information of the system 100 may be stored. Accordingly, the memory 108 may include a non-transitory memory which may store information generated by the system 100 such as information related to medical treatments, medical symptoms, medical conditions, user information, professional information, schedules, operating programs, applications, settings, history, and/or other information of the system 100. The memory 108 may include non-transitory portions which are located locally and/or remotely from each other. Accordingly, the memory 108 may include a distributed memory such as a surface area network (SAN) or the like. Moreover, the memory 108 may be accessible via a local connection or remotely over a network such as the network 114. In accordance with embodiments of the present system, the memory 108 may include a transmission medium.

The MRR 102 may include a medical information memory (MIM) of the system and may therefore include medical records (MRs) such as MR of one or more users (hereinafter patients of the sake of clarity unless the context indicates otherwise) and may be located in one or more locations which may be local and/or remote from each other. The MIM may include a distributed memory which may include medical records of one or more medical providers (such as doctors, hospitals, etc.); health professionals (e.g., chiropractors, psychologists, acupuncturists, medical testing centers, etc.); insurance companies; medical organizations; national or private medical databases; private medical memories (e.g., medical records of a patient stored on a private memory of the patient); etc., which may individually and/or collectively form a MR of one or more users. Thus, the system 100 may query a plurality of MIMs to obtain MRs of one or more users. Accordingly, the MRR 102 may be queried (e.g., accessed) by, for example, the server 106, the USs 112-x, etc., to obtain MRs related to the query. For example, the system may determine whether any current test results of a user 191 are available and obtain these results from the MIM. The MRR 102 may further filter or other restrict access to MRs in accordance with access rules so as to enforce privacy and/or confidentiality settings of the user and/or system 100. The MRR 102 may for example further include information related to medications which a user may be taking.

Selection, access and/or retrieval of medical records of a user is discussed in U.S. Patent No. 61/418,395 the contents of which are incorporated herein by reference.

The sensors 110 may include a plurality of sensors such as sensors 110-1 through 110-N (generally 110-x) which may sense and generate corresponding sensor information. For example, the sensors 100-x may include one or more medical devices which may provide information such as pulse rate sensors, blood pressure sensors, blood glucose level sensors, blood oxygen level sensors, pulse rate sensors, electrocardiograph (ECG or EKG) sensors, imaging sensors, temperature sensors, biometric sensors, fingerprint sensors, iris sensors, genetic sequencers (e.g., DNA testers, coder/decoders, etc.), sound sensors (e.g., a microphone, etc.), etc., which may sense information related to a patient and report corresponding information as raw (e.g., blood pressure=100 mm Hg) or processed (e.g., blood pressure high) sensor information. Thus, the sensor information may include information such as information related to a patient's vital signs, image, positions (e.g., standing, holding hand, etc.), body motions (e.g., rubbing stomach), etc.), location, and/or other information related to the patient. This information may be referred to as body monitoring readings of a patient. The sensors 110-x may include wired and/or wireless sensors.

In accordance with embodiments of the present system, the sensors 110-x may also include imaging devices such as cameras which may capture image and/or video information related to a patient such as via a wireless device (e.g., a wireless US 112-x, etc.). Accordingly, the sensors may determine whether a user's gate is normal, etc. The sensor information such as the image information or other biometric information of a patient may be processed to identify (ID) a patient, symptoms of a patient, a medical condition of a patient, etc. Methods to determine symptoms and/or medical conditions of a patient are discussed in U.S. Patent Application No. 61/418,395, the contents of which are incorporated herein by reference.

The USs 112-1 thorough 112-M (generally 112-x) may include any suitable communication device with which a user may interact with the system and/or which may transmit and/or receive information from one or more of the MRR 102, the schedule resources 104, the server 106, the memory 108, the sensors 110, and/or other USs 112-x. The USs 112-x may include a user interface (UI) 113 with which a user may interact with the US 112-x and/or sensors such a microphone, a camera, etc. Accordingly, USs 134-x may include devices such as, for example, telephony devices (e.g., mobile stations (MSs), cellular phones, smart phones, softphones (e.g., Internet Protocol (IP) Phones), conventional phones, etc.), personal digital assistances (PDAs) such as, for example, PALM™, RIM™, iPad™, and other similar types of devices, personal computers (PCs), notebooks, netbooks, computing pads, and/or other types of communication devices. Further, the USs 112-x may include medical devices (e.g., a medical imaging device, an EKG, a blood pressure monitor, etc.) which may include sensors 110-x and may report various information such as sensor information to the server 106 in raw and/or processed form.

The schedule resources 104 may include schedule information related to the schedules 116-1 through 116-M (generally 116-x) of one or more providers of professional services (POPS) such as medical services (e.g., a doctor, a doctor's office, a hospital, a clinic, etc.) or other related services (e.g., a chiropractor's office, an acupuncturist, dialysis centers, an outpatient treatment center, etc.). Accordingly, the schedule resources 104 may provide information related to a schedule (e.g., including appointments such as available appointment times, office hours, etc.) of a corresponding POPS which may, for example, include schedules for a plurality of patients, and availability of tests, treatments, resources (e.g., testing/treatment equipment such as MRI, dialysis, etc., availability of resources, etc.), and/or professionals (e.g., by day, date, time, etc.), Accordingly, the schedule resources 104 may indicate that Doctor's Hospital, has an MRI imaging device available on Wednesday, Jan. 26, 2026 available from 3:00 to 4:00 pm. Moreover, the schedule resources may provide information related to an available treatment, test, resource, professional, etc. For example, with regard to a resource, the schedule resource may provide information such as its model type, operation, accuracy, speed, age, etc. Further, with regard to a professional, the schedule resources may provide information related to the professional such as the professionals qualifications, specialty, etc. This information may be used by the system to select treatments, etc., as will be described below. The information related to the schedules 116-x may be accessed in real-time using any suitable access and/or retrieval methods such as query/response methods, etc. Further, information in the response may be subject to access rules which may define privacy and/or access restrictions which may be set by the system and/or the corresponding POPS. Thus, server 106 may request a schedule 116-x for a corresponding POPS and/or resource availability on a certain date (e.g., Jan. 25, 2015) and may receive corresponding schedule information. The schedules 116-x may then be updated in accordance with one or more appointments determined by the scheduling system 100 and stored in a memory of the system such as the schedule resources 102 and/or the memory 108 for later use.

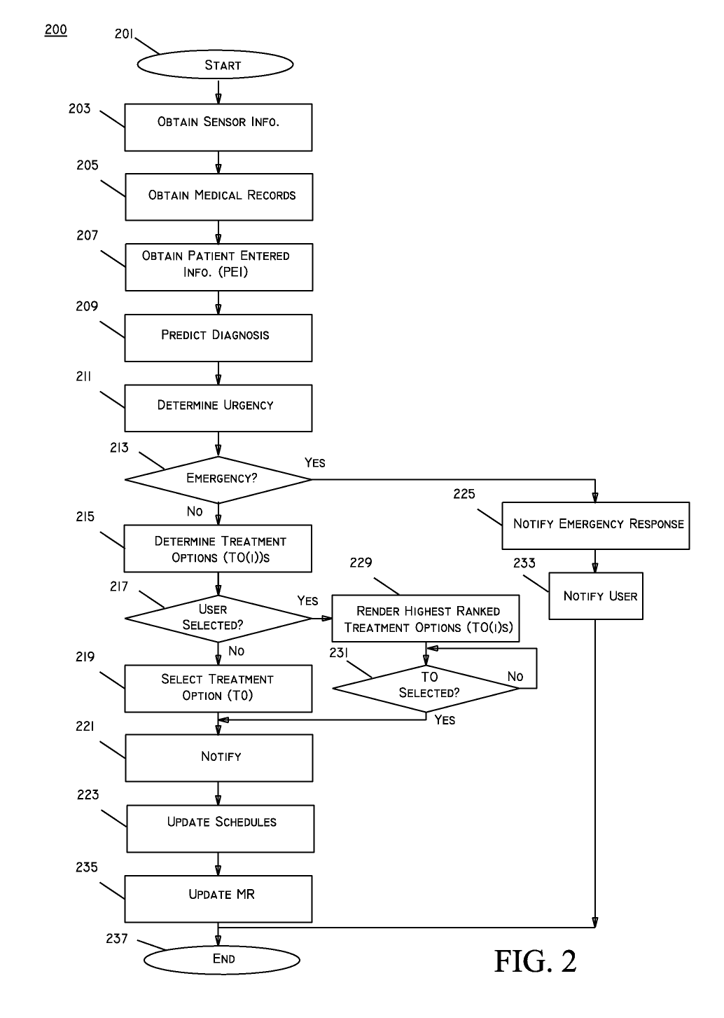

FIG. 2 shows a flow diagram that illustrates a process 200 in accordance with embodiments of the present system. The process 200 may be performed using one or more computers communicating over a network such as the network 114. The process 200 may include one of more of the following acts. Further, one or more of these acts may be combined and/or separated into sub-acts, if desired. During process 200 only a single user (e.g., the user 191) may be discussed for the sake of clarity, however, the operative acts of the process 200 may be performed for a plurality of patients. In operation, the process 200 may start during act 201 and then proceed to act 203.

During act 203, the process may obtain sensor information from one or more sensors of the system. The sensor information may correspond with information related to one or more patients of the system. However, as discussed above only a single patient will be discussed during this process. The sensor information may include information related to an identification of a patient (e.g., an account, a ID of a patient (e.g., John Doe III), a patients address, etc.), a location of the patient (e.g., a geophysical location), a place (e.g., Alternier University Medical Center, Home, Work, etc.), medical sensor information (e.g., providing body monitoring readings such as vital signs (e.g., blood pressure, pulse, breathing rate, temperature, glucose levels, etc.)), or other physiological readings of the patient, a preliminary medical diagnosis (e.g., “elevated blood pressure,”, etc., obtained from a sensor such as a blood pressure monitor), image information related to a corresponding patient (e.g., still or video images obtained using any suitable imaging method such as visible still, video, x-ray, MRI, etc.), etc. The sensor information may be obtained in response to a request (e.g., obtain blood pressure, etc.) or may be pushed to a processing portion of the system at periodic or non-periodic intervals or in response to an event (e.g., in response to detection of an erratic heartbeat, etc.), etc. Thus, the system may include a look up table which may include events (e.g., see erratic heartbeat example above) and corresponding courses of action. After completing act 203, the process may continue to act 205.

During act 205, the process may obtain medical records corresponding with the patient from a memory of the system such as the MRR 102, if desired. The process may obtain all medical records of a patient (e.g., EMR, PHR, and/or EHR, etc.) or may obtain certain medical records of the patient which may be filtered so as to provide only records which match certain filtering requirements such as most recent records (e.g., past six months, etc.) and/or records associated with current symptoms and/or medical conditions of a patient. For example, if the sensor information indicates that the patient is having heart palpitations and/or an erratic heartbeat the process may determine (e.g., using a table lookup) to obtain medical records of this patient related to this sensor information (such as cardiovascular, etc., records of the patient). Thus, if the sensor information of the patient is indicative of a possible medical condition such as a cardiovascular medical condition, the process may request medical records of the patient which correspond with the patient's cardiovascular system. By filtering the medical records in accordance with the sensor information, the process may conserve resources, and obtain medical records which are considered relevant to diagnosing the patient which can save time when reviewed by, for example, a professional such as a POPS. Further, methods to obtain medical records of a patient are disclosed in U.S. Patent No. 61/427,031, the contents of which are incorporated herein by reference. After completing act 205, the process may continue to act 207.

During act 207, the process may interact with the patient (or a representative of the patient) to obtain patient entered information (PEI) such as complaints (e.g., patient symptoms such as vomiting, feeling dizzy, pain in abdomen, etc.) and/or pain the patient may be experiencing. Accordingly, the process may provide a UI to interact with the patient to obtain the PEI. For example, the process may provide an interactive voice response system (IVR) to interact with the patient and obtain the PEI. The process may further include a natural language engine to translate natural language terms entered by the patient. Further, the process may include voice-to-text (VTT) and/or text-to-voice (TTV) applications to provide proper conversion of information. Accordingly, a user may verbally communicate with the system and input, for example, information related to how the user feels (e.g., “I feel faint,” “I have a pain in my lower abdomen,” etc.) and the system may convert this information into another format suitable for processing such as a text format. In accordance with embodiments of the present system, the present system may utilize recognition of a body part as disclosed in the U.S. Patent No. 61/418,395 which is incorporated herein in its entirety such that the patient can use gestures in addition to voice recognition to point where it hurts for instance. Further, the UI may include information which may be based upon the sensor information. For example, if the process determines that the patient has a rapid heartbeat, the process may ask the patient whether the patient feels dizzy, is in pain, or has been exercising, etc., or other information which may be useful to predict a diagnosis of the patient as will be explained below. After completing act 207, the process may continue to act 209.

During act 209, the process may predict a diagnosis of the patient. Accordingly, the process may analyze information related to the patient such as the sensor information (e.g., obtained during act 203), MRs of the user (e.g., obtained during act 205, if available), and/or the PEI associated with the patient (e.g., obtained during act 207, if available) and predict a diagnosis for the patient using any suitable method such as a table lookup, a medical diagnosis database, a medical diagnostics application, etc. For example, the process may predict a diagnosis by obtaining body sensor readings of the patient such as images (e.g., obtained from an image capture device such as a camera of the system), breathing rates (e.g., obtained by analyzing audio information of the patient breathing captured from a microphone of the system), and/or temperature (e.g., obtained from a temperature sensor of the system such as an infrared temperature sensor), and predict that the patient has a respiratory ailment. After completing act 209, the process may continue to act 211.

Referring back to act 209, it is further envisioned that the predicted diagnosis may be set by the system as a preliminary predicted diagnosis when it is desired to obtain further medical records of the patient. Then, the process may repeat act 205 to obtain MR of a patient related to the preliminary predicted diagnosis which may be used to further refine a predicted diagnosis in embodiments of the present system when act 209 (and possibly one or more of acts 207 and 203, as desired) is repeated after act 205.

During act 211, the process may determine an urgency for the user. The urgency may be based upon one or more of the predicted diagnosis (e.g., diagnosis is critical, non-critical, etc.) and pain (e.g., experienced by the user). The urgency may be assigned a corresponding value or range of values. For example, in embodiments of the present system an urgency value of 10 may be indicative of the greatest urgency (e.g., critical) and 0 is indicative of the least urgency. However, other values and/or ranges are also envisioned. Thus, an urgency value of 10 may be assigned to indicate a critical emergency (e.g., when it is determined that the patient is unconscious, etc.) while an urgency of 0 may indicate that treatment of the predicted diagnoses is not urgent and may wait. Accordingly, the process may refer to a lookup table or urgency guidelines to determine the urgency for the user in accordance with one or more of the predicted diagnosis and/or the pain experienced by the user (e.g., entered by the patient in the PEI, etc.). The process may also set a time risk (TR) to correspond with the urgency of the user. Thus, the TR may include a numerical range such that an urgency value of 10 may be reflected as a TR having a value of 10. Similarly, an urgency of 0 may be reflected as a TR having a value of 0. After completing act 211, the process may continue to act 213.

During act 213, the process may determine whether emergency care is required. Accordingly, the process may compare the urgency value with a threshold urgency value (e.g., obtained from a memory of the system) and if it is determined that the urgency value is greater than or equal to the threshold urgency value, the process may continue to act 225. However, if it is determined that the urgency value is less than the threshold urgency value, the process may continue to act 215.

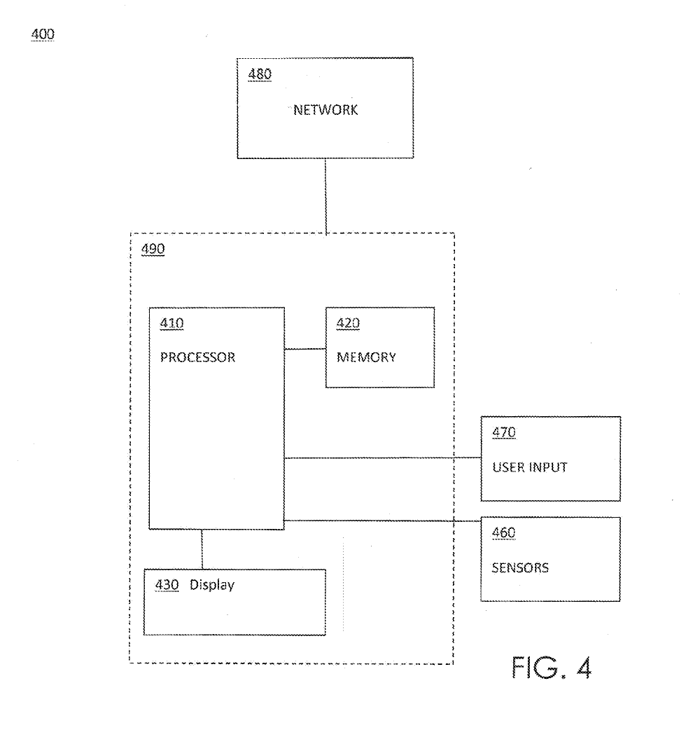

During act 215, the process may determine one or more treatment options TO(i) for each patient. A method to determine TO(i)s for each patient is provided with reference to act 413 of FIG. 4. After completing act 215, the process may continue to act 217.

During act 217, the process may determine whether a patient desires to select from recommended treatment options. Accordingly, if it is determined that the patient desires to select from recommended treatment options, the process may continue to act 229. However, if it is determined that the patient does not desire to select from recommended treatment options, the process may continue to act 219.

During act 219, the process may select the treatment option which is the closest match (or best fit) from the plurality of TO(i). Accordingly, for example, the process may rank the plurality of TO(i)s and select the highest ranked one as the selected treatment option (TO). The treatment option may have an associated appointment time, place, etc. As this act is similar to act 307, a further description thereof will not be given. After completing act 219, the process may continue to act 221.

During act 221, the process may notify the patient of the selected TO and related information such as day, date, time, and/or place of appointment, contact addresses or numbers (e.g., email address, telephone numbers, etc.), names of POPS, etc. using any suitable method. Accordingly, the process may transmit information related to the appointment such as a name of the selected POPS, the location of the selected POPS, the name(s) of professionals who are to be seen, the appointment time, etc., via any suitable contact method such as by rendering the information related to the appointment to on a screen of the user's US. However, it is also envisioned that the process may notify a patient by transmitting information related to the appointment via on or more transmission methods such as via an email, a short message service (SMS), a social networking application (e.g., Facebook™, Twitter™, etc.), a telephone call, a computer application, etc., to inform the user of the appointment. Thus, for example, the process may obtain desired contact methods for a corresponding user from a memory of the system and contact the user in accordance with the desired contact method. After completing act 221, the process may continue to act 223.

During act 223, the process may update schedules in accordance with the TO. Accordingly, the process may inform a scheduling application (e.g., of the system and/or of the POPS) of information relate to the TO. Accordingly, the process may communicate with the scheduling application of the POPS corresponding with the TO to update the schedules, etc. Further, the process may communicate with a scheduling application of the patient (e.g., Microsoft™ Outlook™, etc.) to update a schedule of the patient in accordance with the appointment. After completing act 223, the process may continue to act 235.

During act 235, the process may update the medical records of the patient in accordance with information generated during the process such as the selected TO, the sensor information, the predicted diagnosis, etc., and store this information in a memory of the system such as the MRR for later use. After completing act 235, the process may continue to act 237 where it ends.

In the case of a determined emergency (e.g., determined during act 213), during act 225, the process may notify an emergency services provider of the patient's emergency need for assistance. Accordingly, the process may transit information related to the patient such as the patient's name, current location, predicted diagnosis, medical records (e.g., EMR, PHR, and/or EHR) to an emergency services provider which is determined to be closest to the patient for proper dispatching of an emergency response unit. After completing act 225, the process may continue to act 233. During act 233, the process may notify the patient that an emergency services unit was called using any suitable contact method and continue to act 237.

In a case where the patient desires to select from recommended treatment options (e.g., during act 217), the process may continue to act 229 during which the process may render several highest rated TO(i)s on a UI of the patient for selection by the patient. For each TO(i), the process may provide related information such as day, date, time, a POPS name, address, etc. After completing act 229, the process may continue to act 231.

During act 231, the process may determine whether the patient has selected a TO from the listed TO(i)s. Accordingly, if it is determined that the patient has selected the TO (i.e., the selected TO), the process may continue to act 221 as previously discussed. However, if it is determined that the patient has not selected the TO, the process may repeat act 231.

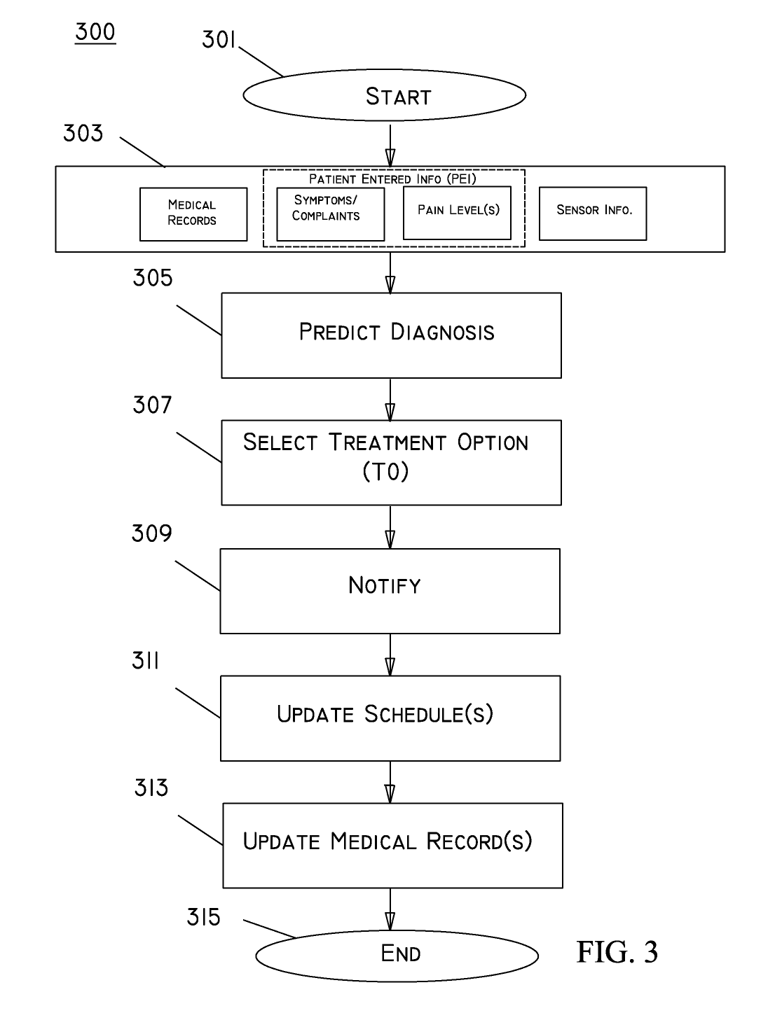

FIG. 3 shows a flow diagram that illustrates a process 300 in accordance with embodiments of the present system. The process 300 may be performed using one or more computers communicating over a network such as the network 114. The process 300 may include one of more of the following acts. Further, one or more of these acts may be combined and/or separated into sub-acts, if desired. In operation, the process 300 may start during act 301 and then proceed to act 303.

During act 303, the process may obtain information related to one or more patients which may include, for example, medical records, sensor information (e.g., vital signs, etc.), symptoms, pain levels of a corresponding user, etc. The symptoms and/or pain levels may be determined by the system (e.g., based upon sensor information, user inputs, and/or symptoms) and/or may be input by a user such as the patient, a professional, etc. After completing act 303, the process may continue to act 305.

During act 305, the process may predict a diagnosis for each patient based upon the information obtained during act 303. The process may determine the predicted diagnosis using any suitable method such as a table look up, a diagnostic application, etc. As this process may be similar to act 209 of FIG. 2, a further description thereof will not be given for the sake of clarity. After completing act 305, the process may continue to act 307.

During act 307, the process may select a treatment option (TO) for each patient based upon, for example, consumer selection of a TO and/or one or more treatment factors (TF) such as TF(1) through TF(i)) which may respectively correspond with a location risk (LR), a time risk (TR), a treatment risk (TT), a quality of treatment (QT), and treatment popularity (TP) for each of patient. Various factors which may influence these treatment factors are shown in Table 1 below. However, other factors are also envisioned and may be set by the system and/or user.

TABLE 1
Treatment Factors (Exemplary)

| 1. | Location Risk (LR) - This is a factor that evaluates if the location of the | |
|---|---|---|
| | treatment facility is too far for the patient to commute to. The location risk | |
| | may be calculated using any suitable method and, for example, may be | |
| | based on the following sub-factors which, for example, may be added | |
| | together to determine the LR: | |
| | a. | Distance between a patient's home (or location (e.g., work, travel, |
| | | etc.) at time of appointment) to treatment facility. This distance may be |
| | | determined by the system using, for example, a suitable application |
| | | which may take into account a patient's schedule (e.g., Jan. 2, 2022) to |
| | | determine an expected location at various times. Thus, when |
| | | determining to schedule a patient, this information may change based |
| | | upon day/date/time information. Thus, the closer a treatment facility is |
| | | to a patient, the higher the score. Conversely, the further a treatment |
| | | center is from a patient the lower the score. |
| | b. | Method of transportation the patient typically uses. For example, |
| | | this information may be obtained from any suitable source such as |
| | | PHR/EMR/EHR, an input from a patient, etc. A score for this sub- |
| | | factor may be based upon a fit between a corresponding treatment |
| | | facility and accessibility to transportation methods of a patient. For |
| | | example, assuming that a patient is using public transportation, a |
| | | treatment facility (TF(i)) which is convenient (e.g., has a stop which is |
| | | close by) to public transportation may obtain a higher score than a |
| | | treatment facility which is not easily accessible by public transportation. |
| | | This sub-factor may also take into account transportation time, etc. |
| | c. | Patient's mobility based on age and current conditions. This |
| | | information may, for example, be obtained from any suitable source |
| | | such as from PHR/EMR/EHR and/or a predicted diagnosis of the |
| | | patient (e.g., a broken knee, femor, etc., would generally preclude the |
| | | patient from taking public transportation. Accordingly, the method of |
| | | transportation may be affected (e.g., patient may have to take private |
| | | transportation as opposed to public transportation). Accordingly, each |
| | | treatment facility may have a score which may be determined access |
| | | to the patient due to the patient's mobility and current conditions. For |
| | | example, if there is a blizzard in NY or it is late at night (e.g., 3 am), |
| | | access to treatment facilities may be scored based upon current |
| | | conditions. Thus, a patient who may normally walk a half mile to a |
| | | treatment facility may be incapable of walking during the blizzard or |
| | | may not want to walk at 3:00am due to safety reasons. Thus, the |
| | | process may take into account user convenience. |
| 2. | Time Risk (TR) - This factor may be used to evaluate urgency of treating a | |
| | particular diagnosis (e.g., the current MC) in order to achieve a successful | |
| | outcome and not make a condition such as the current MC worse. Time risk | |
| | may be calculated based on the following factors: | |
| | a. | User's pain level, severity of qualitative input, and severity of |
| | | biometrical readings; and |
| | b. | Medical database evaluation of predicted diagnosis and its |
| | | recommended optimal treatment time based upon a treatment |
| | | availability at a facility. |

Thus, a treatment option which may be immediately available at a facility may
have a higher score than a treatment option which may be delayed. Further, the
patient's pain level may be as a multiplier to further refine the score. For
example, if a patient is in severe pain (e.g., 10 indicating a highest level), this
may be used to multiply (e.g., .linearly or non-linearly) a score corresponding
with the treatment availability at a facility.

| 3. | Quality of treatment (QT) is a listing of facilities and their target treatments | |
|---|---|---|
| | for the predicted diagnosis along with an outcome success rate for each | |
| | target treatment | |
| | a. | Each facility can have one or more treatments for a particular |
| | | diagnosis, each associated with an individual success rate |
| | b. | Each facility database provides data for treatments and their |
| | | success rates |

Generally, the higher the success rate, the higher the score. Conversely, the
lower the success rate, the lower the score. These scores may be obtained from
a POPS and/or from a memory of the system.

| 4. | Popularity of Treatment (aka treatment popularity TT) is a listing of | |
|---|---|---|
| | facilities and their target treatments for the predicted diagnosis along with an | |
| | estimated demand for the target treatment in the timeframe that is available | |
| | to treat the patient. The popularity of treatment may have several sub- | |
| | factors which may be combined to determine a score such as: | |
| | a. | Each facility can have one or more treatments for a particular |
| | | diagnosis along with a demand estimation for each treatment; and |
| | b. | Each facility database provides data for treatments and their |
| | | demand estimation. |

These sub-factors may be set by, for example, a POPS such as a hospital.
Generally, the more popular a treatment is, the higher its score may be.
Accordingly, the score may be obtained from a plurality of users who may rank a
treatment option using, for example, an online method (e.g., a via social
networking website, etc.).

However, other treatment factors which may be set by the system and/or patient are also envisioned in accordance with embodiments of the present system. For example, the TFs may be selected by the system in accordance with a default setting and/or in accordance with one or more of patient information and/or predicted diagnosis. The TFs may further be weighed (e.g., using a corresponding weighing factor (W) such as W1 through Wi in accordance with importance of each factor so that important factors are given more consideration (weight) than other less important factors. Similarly to the TFs, the weights may be selected in accordance with a default setting and/or in accordance with one or more of patient information and/or predicted diagnosis. However, the methods used to select the weights and/or the TFs may be different from each other. For example, the 1^{st} through i^{th} TFs may be selected from a default configuration (e.g., stored in a memory of the system) and the corresponding weights (e.g., the 1^{st} through i^{th} weights) may be selected for the default configuration of TFs in accordance with one or more of information related to a patient such as age, gender, preexisting medical conditions, symptoms, predicted diagnosis, urgency, etc.

Further, as the TFs may vary by treatment types, facilities, and/or timing (times), the TO may be expressed as a function of the treatment type, facility, and/or timing as expressed by Equation 1 below.

TO(Treatment Type(ty),Facility(fa),Timing(tm))=F((W1)(TF1)+(W2)(TF2)+(W3)(TF3)+ . . . +(Wi)(TF(i)) Eq. (1)

Accordingly, the process may find a closest match of the TO in accordance with the TFs using any suitable method. For example, the process may select a TO having the highest value of a plurality of TOs (where a TO may be computed for each combination of treatment type, facility, and/or timing (time)). This is illustrated with reference to Table 2 below.

TABLE 2

| | POSSIBLE TREATMENT (for predicted medical condition) | | | | |
|---|---|---|---|---|---|
| | TF(1) (surgical) | TF(2) (surgical) | TF(3) (body cast) | TF(4) (hard cast) | TF(I) (ultrasonic) |
| | Northslope Hosp. | Northslope Hosp. | The Free Clinic | Hardtimes Clinic | Adv. Healing Institute |
| | Dr Jones | Dr Jones | Dr. Smyth | Dr. John | Dr. Jay |
| | ty = surg | ty = surg | ty = cast | ty = surg | ty = |
| Predicted | fa = NSH | fa = NSH | fa = TFC | fa = HTC | fa = NSH |
| Medical | tm = 2:00 pm | tm = 3:00 am | tm = 7:00 pm | tm = 2:00 pm | tm = 1:00 am |
| Condition | Jan. 5, 2013 | Jan. 5, 2013 | Jan. 5, 2013r | Jan. 5, 2013 | Jan. 5, 2013 |

| | | | | | |
|---|---|---|---|---|---|
| BROKEN | LR = 4 | LR = 4 | LR = 10 | . . . | LR = 2 |
| FEMUR | TR = 6 | TR = 6 | TR = 1 | | TR = 10 |
| | TT = 5 | TT = 9 | TT = 1 | | TT = 10 |
| | QT = 9 | QT = 9 | QT = 1 | | QT = 10 |
| F((W1)(TF1)) | 49 | 57 | TP = 27 | . . . | TP = 65 |
| Rank | 5 | 8 | 3 | | 10 |
| Selected TO | | | | | X |
| (TOₛₑₗ) | | | | | |

Table 2 illustrates a plurality treatment options TO(i) available to treat the patient's medical condition (e.g., a broken femur in the present example). The treatment options may have a TR, TT, QT, and TP (where higher numbers may be equated with lower risk and/or higher quality of treatment. Thus, an ultrasonic (non-surgical) instant bone healing method may be ranked higher than a surgical (e.g., pin insertion) method of bone repair. The process may obtain the treatment options from a memory (e.g., femur repair available options=surgical, ultrasonic, and cast setting methods) of the system and may then determine the available POPS, times, etc., by obtaining corresponding information from the schedule resources. The schedule resources may include information related to available resources (e.g., surgical rooms for performing surgery, machines for medical procedures, etc.) professional availability (e.g., doctor availability, e.g., Dr. Jones available time slots Wed. Jan. 1, 2020 9:00 AM-12:30 PM, etc.), etc. The process may then determine the LR, TR, TT, and QT for a corresponding available treatment option. Thus, for example, the process may calculate the TOs for a plurality of treatment types, facilities, and/or timing (e.g., times and/or availability), and thereafter rank each of these TOs based upon their calculated values. In the present example, it is assumed that the rank is proportional to the calculated value and, in the present example, it may be assumed that the higher the rank, the closer the match. Then, the process may select the TO with the highest rank as the selected TO (TOₛₑₗ). Accordingly, the selected TO (e.g., TOₛₑₗ) may have the closest match. It is further envisioned that the process may obtain a plurality (e.g., 3, etc.) of TOs with the highest ranking and filter these highest ranking TOs to obtain the selected TO at a later time (e.g., in accordance with a users selection, etc.). Accordingly, the process may present the TOs with the highest rankings (e.g., the three highest ranking TOs of all of the ranked TOs) for the user's selection, and then, the process may select the TO in accordance with the user's selection, if desired. After completing act 307, the process may continue to act 309.

During act 309, the process may notify the patient of the TO and related information such as day, date, time, and/or place of appointment, contact addresses or numbers (e.g., email address, telephone numbers, etc.), names of POPS, etc. using any suitable method. It is further envisioned that the process may contact both the patient and a POPS and form a communication channel (e.g., via a telephone call, etc.) between the patient and a selected representative of the POPS (e.g., Dr. Jones, Dr. ‘Jone's receptionist, etc.) in the current example, if desired. As this act may be similar to act 221, a further description thereof will not be given for the sake of clarity. After completing act 309, the process may continue to act 311.

During act 311, the process may update schedules in accordance with the TO. Accordingly, the process may inform a scheduling application (e.g., of the system and/or of the POPS) of information relate to the selected TO. As this act may be similar to act 223, a further description thereof will not be given for the sake of clarity. After completing act 311, the process may continue to act 313.

During act 313, the process may update the medical records of the patient in accordance with information generated during the process such as the TO, the sensor information, the predicted diagnosis, etc., and store this information in a memory of the system such as the MRR for later use. After completing act 313, the process may continue to act 315 where it ends.

FIG. 4 shows a portion of a system 400 (e.g., control portion, retrieval portion, object recognition portion, image capture portion, etc.) in accordance with embodiments of the present system. For example, a portion of the present system may include a processor 410 operationally coupled to a memory 420, a display 430, a sensors 460, and a user input portion 470. The sensors 460 may include any suitable sensors such as medical sensors (e.g., glucose sensors, pressure sensors (e.g., blood pressure, breathing pressure, etc.), pulse rate sensors, oxygen level sensors, acoustic sensors, biometric sensors (e.g., fingerprint sensors, DNA analyzers, etc.), fluid testing devices, imaging devices such as, for example, a camera, a video camera, a live stream, an x-ray device, computed tomography (CT scan), sonogram, and/or other imaging system, which may provide one or more images of one or more users, radiation sensors, etc. which may provide sensor information which may be analyzed by the system to determine a medical condition of the user. The memory 420 may be any type of device (e.g., non-transitory) for storing application data as well as other data related to the described operation. The application data and other data are received by the processor 410 for configuring (e.g., programming) the processor 410 to perform operation acts in accordance with the present system. The processor 410 so configured becomes a special purpose machine particularly suited for performing in accordance with the present system.

The operation acts may include requesting, providing, and/or rendering of patient's MR or filtered portions thereof. The user input portion 470 may include a keyboard, mouse, trackball or other device, including touch sensitive displays, which may be stand alone or be a part of a system, such as part of a personal computer, personal digital assistant, mobile phone, set top box, television or other device for communicating with the processor 410 via any operable link. The user input portion 470 may be operable for interacting with the processor 410 including enabling interaction within a UI as described herein. Clearly the processor 410, the memory 420, display 430 and/or user input device 470 may all or partly be a portion of a computer system or other device such as a client and/or server as described herein.

The methods of the present system are particularly suited to be carried out by a computer software program, such program containing modules corresponding to one or more of the individual steps or acts described and/or envisioned by the present system. Such program may of course be embodied in a computer-readable medium, such as an integrated chip, a peripheral device or memory, such as the memory 420 or other memory coupled to the processor 410.

The program and/or program portions contained in the memory 420 configure the processor 410 to implement the methods, operational acts, and functions disclosed herein. The memories may be distributed, for example between the clients and/or servers, or local, and the processor 410, where additional processors may be provided, may also be distributed or may be singular. The memories may be implemented as electrical, magnetic or optical memory, or any combination of these or other types of storage devices. Moreover, the term “memory” should be construed broadly enough to encompass any information able to be read from or written to an address in an addressable space accessible by the processor 410. With this definition, information accessible through a network is still within the memory, for instance, because the processor 410 may retrieve the information from the network for operation in accordance with the present system.

The processor 410 is operable for providing control signals and/or performing operations in response to input signals from the user input portion 470, the image capture portion 460, as well as in response to other devices of a network and executing instructions stored in the memory 420. The processor 410 may be an application-specific or general-use integrated circuit(s). Further, the processor 410 may be a dedicated processor for performing in accordance with the present system or may be a general-purpose processor wherein only one of many functions operates for performing in accordance with the present system. The processor 410 may operate utilizing a program portion, multiple program segments, and/or may be a hardware device utilizing a dedicated or multi-purpose integrated circuit.

Thus, embodiments of the present system may enhance the quality of healthcare for the largest amount of patients by methodically prioritizing related treatments in according to several factors such as their appropriateness to the patient, their availability, etc. Thus, using embodiments of the present system, a patient may be diagnosed by the system and provided with one or more treatment types to choose from. While similar in the ultimate health outcome for the patient, treatment types can be classified based on specific parameters that best help a medical system determine when, where, and how to treat the patient, in comparison with other patients that need similar treatment at a similar time at a similar place and anticipation of future patients with similar treatment needs.

Thus, in accordance with embodiments of the present system, a process to select treatment types for a patient of a plurality of patients may obtain information related to a patient such as sensor information (e.g., via real time body monitoring, location information, etc.); medical records (e.g., EMR, EHR, PHR, etc.); and/or user inputs which may include information related to current symptoms, qualitative descriptions (e.g., “I have a stomach ache,” “I would like to visit a doctor in NYC”, etc.), medications, etc., and predict a diagnosis.

Each predicted diagnosis may have an associated treatment type list which may be ranked numerically in accordance with treatment factors such as:
(a) a patients' risk if treatment is not delivered at a specific time and location; overall efficacy of treatment type to patients' post treatment well being;
(b) risk of treatment type not treating the patient properly as required by the predicted diagnosis;
(c) immediate popularity of treatment type as compared to available treatments; and/or
(d) location and times where treatment type is available.

Then, a treatment type with a highest ranking of a plurality of treatment types may be selected and/or a plurality of treatment types with highest ranking may be rendered for selection of a treatment type (e.g., selected treatment type) by a user. In accordance with embodiments of the present system, the process may automatically schedule the user in accordance with the selected treatment type.

Further, each treatment factor may be given a corresponding weight that will help determine how important a particular treatment factor is to another treatment factor in order to properly determine the overall appropriateness of a particular treatment type. Then, based on the treatment factors and/or their respective weights, the system may determine a most appropriate treatment type for the needs of a particular patient of a plurality of patients. Further, the system may determine medical scheduling for a plurality of patients based upon resource availability of a provider of professional services such as a hospital, a medical office, a clinic, etc.

Finally, the above-discussion is intended to be merely illustrative of the present system and should not be construed as limiting the appended claims to any particular embodiment or group of embodiments. Thus, while the present system has been described with reference to exemplary embodiments, it should also be appreciated that numerous modifications and alternative embodiments may be devised by those having ordinary skill in the art without departing from the broader and intended spirit and scope of the present system as set forth in the claims that follow. In addition, the section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts or steps is intended to be required unless specifically indicated; and

i) the term “plurality of” an element includes two or more of the claimed element, and does not imply any particular range of number of elements; that is, a plurality of elements may be as few as two elements, and may include an immeasurable number of elements.

1. A scheduling system comprising:
at least one controller device, which is configured to:
obtain sensor information comprising one or more of medical sensor and biometric information related to a user;
determine a medical symptom or medical condition of the user in accordance with the sensor information;
schedule an appointment with a provider of professional services (POPS) in accordance with at least one of the determined medical symptom and the determined medical condition of the user; and
notify one or more of the user and the medical provider of the scheduled appointment.

2. The system of claim 1, wherein the controller is configured further to obtain one or more of an electronic medical record (EMR), an electronic health record (EHR), and personal health record (PHR) of the user from a memory of the system.

3. The system of claim 1, wherein the controller is configured further to determine the at least one of the medical symptom and medical condition of the user in accordance with one or more of the electronic medical record (EMR), the electronic health record (EHR), and the personal health record (PHR) of the user.

4. The system of claim 1, wherein the controller is configured further to determine an urgency level in accordance with one or more of a pain level of the user and a risk level of the at least one of the medical symptom and the medical condition.

5. The system of claim 1, wherein the controller is configured further to select one or more treatment options (TOs) to treat the at least one of the medical symptom and the medical condition.

6. The system of claim 1, wherein the controller is configured further to select the POPS from a plurality of POPS in accordance with the TOs or an urgency level.

7. The system of claim 5, wherein to schedule the appointment, the controller is configured to rank the plurality of TOs and selects a highest ranking TO or renders a plurality of highest ranking TOs for the selection of a TO from the plurality of highest ranking TOs by the user.

8. A scheduling method, the method comprising one or more acts which are performed by processor, the acts comprising:
obtaining sensor information comprising one or more of medical sensor and biometric information related to a user;
determining a medical symptom or medical condition of the user in accordance with the sensor information;
scheduling an appointment with a provider of professional services (POPS) in accordance with the determined medical symptom or medical condition of the user; and
notifying one or more of the user and the POPs of the scheduled appointment.

9. The method of claim 8, further comprising an act of obtaining one or more of an electronic medical record (EMR), an electronic health record (EHR), and personal health record (PHR) of the user from a memory of the system.

10. The method of claim 8, wherein the act of determining the medical symptom or medical condition of the user is performed in accordance with information included in one or more of the electronic medical record (EMR), the electronic health record (EHR), and the personal health record (PHR) of the user.

11. The method of claim 8, further comprising an act of determining an urgency level in accordance with one or more of a pain level of the user and a risk level of the medical symptom or medical condition.

12. The method of claim 8, further comprising an act of selecting a treatment option (TO) to treat the medical symptom or the medical condition.

13. The method of claim 8, further comprising an act of selecting the POPS from a plurality of POPS in accordance with one or more of the TO and the urgency level.

14. A computer readable non-transitory memory medium comprising a computer program stored thereon, the computer program configured to perform a scheduling process, the computer program comprising:
a program portion configured to:
obtain sensor information comprising one or more of medical sensor and biometric information related to a user;
determine a medical symptom or medical condition of the user in accordance with the sensor information;
schedule an appointment with a provider of professional services (POPS) in accordance with the determined medical symptom or medical condition of the user; and
notify one or more of the user and the POPs of the scheduled appointment.

15. The computer program of claim 14, wherein the program portion is further configured to obtain one or more of an electronic medical record (EMR), an electronic health record (EHR), and personal health record (PHR) of the user from a memory of the system.

16. The computer program of claim 14, wherein the program portion is further configured to determine the medical symptom or medical condition of the user in accordance with one or more of the electronic medical record (EMR), the electronic health record (EHR), and the personal health record (PHR) of the user.

17. The computer program of claim 14, wherein the program portion is further configured to determine an urgency level in accordance with one or more of a pain level of the user and a risk level of the medical symptom or medical condition.

18. The computer program of claim 14, wherein the program portion is further configured to select one or more treatment options (TOs) to treat the medical symptom or medical condition.

19. The computer program of claim 14, wherein the program portion is further configured to select the POPS from a plurality of POPS in accordance with the TOs or an urgency level.

20. A scheduling system comprising:
at least one controller which is configured to:
obtain sensor information of a user, the sensor information comprising information related to a physiological condition of the user;
determine a medical condition of the user in accordance with the sensor information;
determine one or more treatment options (TOs) to treat the medical condition of the user;
rank the one or more (TOs) in accordance with one or more corresponding treatment factors (TF);
select a TO to be a selected TO from the one or more TOs in accordance with a corresponding rank of each of the TOs;
schedule an appointment with a provider of professional services (POPS) corresponding to the selected TO; and
notify one or more of the user and the POPS of the scheduled appointment.

21. The system of claim 21, wherein the controller is further configured to:
obtain medical records corresponding with the user; and
transmit the medical records corresponding to the user to the selected POPS.
